(19) United States
(12) Patent Application Publication
(10) Pub. No.: US 2021/0346843 A1
(43) Pub. Date: Nov. 11, 2021

(54) RAPID SEPARATION AND RECOVERY OF PATHOGENS FROM FOOD SAMPLES BY MICROFILTRATION ASSISTED COUNTERFLOW ELUTRIATION (MACE)

(71) Applicant: PathOTrak, LLC, College Park, MD (US)

(72) Inventor: Francisco Javier Atencia-Fernandez, Bethesda, MD (US)

(21) Appl. No.: 17/274,000

(22) PCT Filed: Sep. 5, 2019
(86) PCT No.: PCT/US2019/049717

§ 371 Date: Mar. 5, 2021

Related U.S. Application Data
(60) Provisional application No. 62/727,190, filed on Sep. 5, 2018.

(51) Int. Cl. B01D 61/18; B01D 61/14; B01D 69/02; B01D 61/20; C02F 1/44; G01N 1/40

(52) U.S. Cl. CPC B01D 61/18; B01D 61/147; B01D 69/02; B01D 61/20; C02F 1/444; C02F 2103/32; G01N 1/4005; B01D 2325/028; B01D 2311/2649; C02F 2303/04; G01N 1/4077

(57) ABSTRACT

Methods and devices for rapidly separating pathogen from a test sample, such as a food sample, for efficient detection of pathogen are disclosed. A simultaneous microfiltration and elutriation approach was used to separate pathogen, such as bacterial cells, from a test sample, such a food sample.

### FIELD OF THE DISCLOSURE

The present disclosure generally relates to systems and methods for rapid separation of particulates in suspension, including rapid separation and detection of pathogens in food products. Systems and methods for isolating microorganisms from clinical and/or environmental samples are also disclosed.

### BACKGROUND

Foodborne illnesses, caused by various pathogens contaminating the food we eat, affect 1 in 6 Americans each year according to the Centers for Disease Control and Prevention (CDC). The spread of foodborne illnesses can be prevented through careful monitoring of food by producers and sellers, and detection of foodborne pathogens present in the food processing lots. Unfortunately, detection of foodborne pathogens in food using current techniques can be expensive and time consuming, often taking multiple days to obtain results. The resulting delays between processing and sale of certain foods while awaiting results can be problematic, especially with food items such as meat and ready to eat food.

The major bottleneck for rapid food-born pathogen detection in food samples is the time required for the sample preparation step called “bacterial enrichment” (Brehm-Stecher et al., J. Food Prot. 72, 1774-1789 (2009)). Enrichment is the process by which certain amount of a food sample, for example, 25 g of a food sample or 375 g in the case of meats, is diluted in a solution, for example, a growth medium for certain pathogens, homogenized, and incubated for about 18-36 hours to increase the quantity of the pathogen contained therein, such as bacteria. Enrichment can overcome the interference of the food matrix during the downstream processes, such as detection. After enrichment, rapid detection is usually performed in 2-4 hours using a quantitative Polymerase Chain Reaction (qPCR) system. While in the last decade, investment and technical advances have reduced the detection time from days to 2-4 hours, enrichment time has remained unchanged because of the lack of available technological alternatives.

A food matrix is usually composed of a heterogeneous milieu of inorganic particles, biochemical chemicals, and bacterial microflora. Fat, muscle tissue, free DNA, spices, and other biomolecules, etc. can interfere with molecular detection methods. Studies have shown that complex food matrices homogenization or blending of meats and produce may release chemicals that prevent bacterial growth, which is necessary during the enrichment step, or interfere with downstream detection. Enrichment overcomes this problem by diluting the food sample, including inhibitory chemicals, and by increasing the target analytes (pathogens, such as bacteria) by incubation and growth.

Many methods have been proposed to reduce the enrichment time and therefore the overall time to obtain test results (Wang and Salazar, Compr. Rev. Food Sci. Food Saf. 15, 183-205. (2016)). Any alternative method to enrichment would have to separate the pathogens from the food matrix and concentrate the pathogens to detectable levels.

Centrifugation and filtration are the most commonly explored physical separation methods due to their simplicity. Typically, prefiltering is the starting step, where the food sample and liquid media (for example, at 1:9 vol. ratio) are introduced in two compartments of a plastic bag separated by a filter with large pore sizes (around 50 microns). The bag is introduced in a stomacher to homogenize the sample, and the filtered liquid is poured into a new container for further processing. In the case of 375 g of meat samples, the typical volume of the prefiltered liquid is over 3 L.

A 3-stage method was developed using different filter materials in series to separate and concentrate E. coli O157:H7 from large volumes of stomached beef (Brewster, J. Rapid Methods Autom. Microbiol. 17, 242-256. (2009)). Unfortunately, it was reported that the filters get clogged and need several replacements during filtration. Although the method could be used to recover low numbers of bacteria from the sample, it does not meet the regulatory requirements of detecting 1 CFU/sample (Colony Forming Unit/sample) without enrichment. Further, another method was developed that combines prefiltration with steps of centrifugation, floatation, and sedimentation at high and low centrifugation steps to separate and concentrate bacteria, with limits of detection of 10 CFU/g (250 CFU/25 g sample or 2750 CFU/375 g) (Fukushima et al., Appl. Environ. Microbiol. 73, 92-100. (2007)). To prevent filter-clogging, people used enzymatic digestion of prefiltered samples to remove organic particulates, prior to ultrafiltration of bacterial capture and recovery. See, for example, US20180180611 by Ladisch et al. The enzymes used are different depending of the type of food. They reported limit of detection of 1 CFU/ml (250 CFU/sample) of Salmonella in spinach samples in 9 hours, and 1 CFU/25 g of Salmonella in ground turkey in 8 hours (typical samples of meat are 375 g), among others. Similarly, Fachmann et al., developed a protocol that includes 3 hours of enrichment, filtration, and PCR detection in pork pieces that resulted in limit of detection of 8.8 CFU/25 g of Salmonella in pork pieces in 5 hours (Fachmann et al., Appl. Environ. Microbiol. 83, e03151-16. (2017)).

However, the gold standard sample preparation for detection of pathogens in food is enrichment, and to our knowledge, this is the only AOAC international, Food and Drug Administration (FDA), or United States Department of Agriculture (USDA) approved method and the only method used commercially. Any alternative method to enrichment preferably should be cost effective, simple to perform, and have as few steps as possible. Such an alternative method would also have to be compatible with the detection limit of 1 CFU/25 g or 1 CFU/375 g to meet regulations.

Elutriation is commonly used for separating particles based on their size, shape, and density, using a stream of liquid flowing in a direction opposite to the direction of sedimentation. Small or light particles rise to the top (i.e., overflow) where they may be extracted because their terminal sedimentation velocities are lower than the velocity of the rising fluid. Elutriation has been primarily used to separate and collect microplastics in environmental samples (Hurley et al., Environ. Sci. Technol. 52, 7409-7417. (2018), Biasing and Amelung, Sci. Total Environ. 612, 422-435. (2018)), or to separate and collect small animals and microorganisms from marine sediments (Tiemann and Betz, Mar. Ecol. Prog. Ser. 1, 277-281 (1979)). Further, counterflow centrifugation elutriation of small volumes has been used to separate different types of mammalian cells (Turpin et al., J. Clin. Apheresis 3, 111-118 (1986) and Faradji et al., J. Immunol. Methods 174, 297-309 (1994)). Counterflow centrifugal elutriation is a liquid clarification technique. This technique enables scientists to separate different cells with different sizes. Since cell size is correlated with cell cycle stages, this method also allows the separation of cells at different stages of the cell cycle.

To our knowledge, elutriation or counterflow centrifugation elutriation has not been used for the separation of pathogens from food samples, probably because food samples are usually very heterogeneous with some components that would sediment and others that would float, making the pathogen extraction impractical.

The present disclosure provides methods and devices for rapid separation of and optional screening of food or other samples for pathogens such as Salmonella, E. coli O157:H7, etc. Methods disclosed herein may be used to separate and identify pathogens, including but not limited to Salmonella, from a food sample in as little as 2-4 hours, providing a significant improvement over the processes presently available, as detailed above. Such methods have significant commercial, clinical, and/or environmental advantages. For example, by reducing the detection time for foodborne pathogens from days to hours, potential threats to public health may be more quickly identified. Additionally, decreased testing times and lower costs due to reduced warehousing and refrigeration may result in additional testing increasing the safety level of the food-chain supply.

### SUMMARY

Devices and methods for rapid and efficient separation of pathogen from a test sample are provided in the present disclosure. In one embodiment, the present disclosure provides a Microfiltration Assisted Counterflow Elutriation (MACE) separator. In some embodiments, the MACE separator comprises at least one microfiltration membrane configured to contain a test sample, a screening member, a cavity between the at least one microfiltration membrane and the screening member containing the test sample, a cavity above the at least one microfiltration membrane, and a cavity below the screening member, one or more inlets, and one or more outlets. In some embodiments, the MACE separator has more than one microfiltration membranes.

Further provided herein is a method for separating pathogen from a test sample. In some embodiments, the method comprises extracting the pathogen from a test sample by processing the sample in the MACE separator disclosed herein.

### BRIEF DESCRIPTION OF THE DRAWINGS

FIG. 1 illustrates the typical prefiltration step for microfiltration-separations in food safety.

FIGS. 2A-2C show exemplary Membrane Assisted Counterflow Elutriation principle.

FIG. 3 show exemplary Membrane Assisted Counterflow Elutriation (MACE).

FIGS. 4A and 4B show the cross section of an embodiment of the MACE separator.

FIGS. 5A-5D illustrate the method of loading a food sample into an embodiment of the MACE separator, and its operation.

FIGS. 6A-6C are photographs showing an embodiment of the MACE separator built and tested in the lab with a food sample of 187 g of ground beef.

FIG. 7A shows the results of three tests with different experimental conditions. FIGS. 7B and 7C are photographs showing the plates with CFU of testing the efficiency of pathogen separation from ground beef.

FIGS. 8A-8C illustrate different embodiments of the present disclosure.

FIGS. 9A and 9B illustrate different embodiments of the present disclosure.

FIGS. 10A-10C illustrate different embodiments of the present disclosure.

### DETAILED DESCRIPTION

I. Devices and Methods

The present disclosure provides devices and methods for rapid and efficient separation of pathogen from a test sample. In one embodiment, the present disclosure provides a Microfiltration Assisted Counterflow Elutriation (MACE) separator. In some embodiments, the MACE separator comprises at least one microfiltration membrane configured to contain a test sample, a screening member, a cavity between the at least one microfiltration membrane and the screening member containing the test sample, a cavity above the at least one microfiltration membrane, and a cavity below the screening member, one or more inlets, and one or more outlets. In some embodiments, the MACE separator has more than one microfiltration membranes.

As used herein, the term “sample” or “test sample” means any material that contains, or potentially contains, biological material which could be contaminated by the presence of a pathogen. Examples of samples for use in accordance with the disclosure include, but are not limited to, food samples, patient samples (e.g., feces or body fluids, such as urine, blood or cerebrospinal fluid), and environmental samples, such as drinking water or other fluids. Examples of a food sample include, but are not limited to: dairy products such as cheese, yogurt, ice cream or milk, including raw milk; meat such as beef, pork, minced meat, turkey, chicken or other poultry products; ground meat such as ground beef, ground turkey, ground chicken, ground pork; eggs; produce, including fruits and vegetables; peanut butter; seafood products including oysters, pickled salmon or shellfish; or juice, such as fruit or vegetable juice. A test sample may be taken from a source using techniques known to one skilled in the art. In some embodiments, the test sample comprises, or can be separated into, fluid portion and sediment particles.

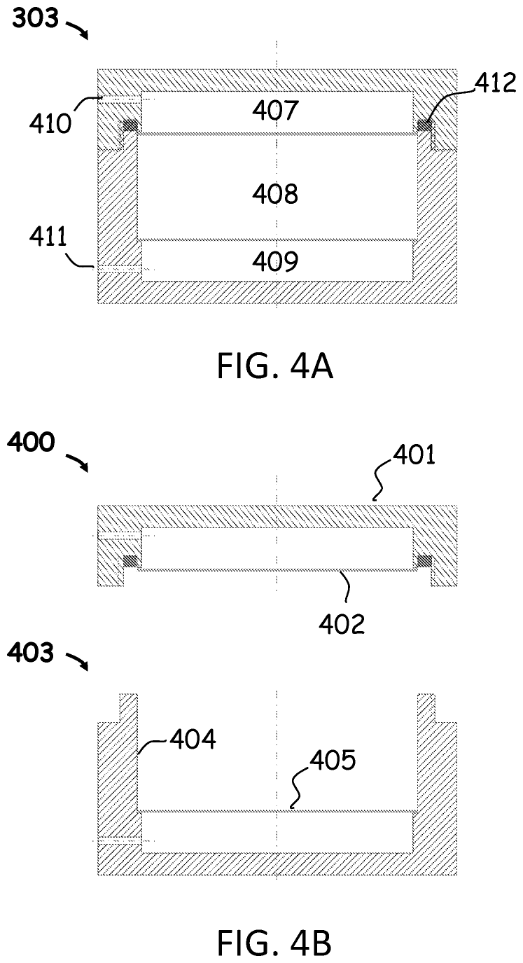

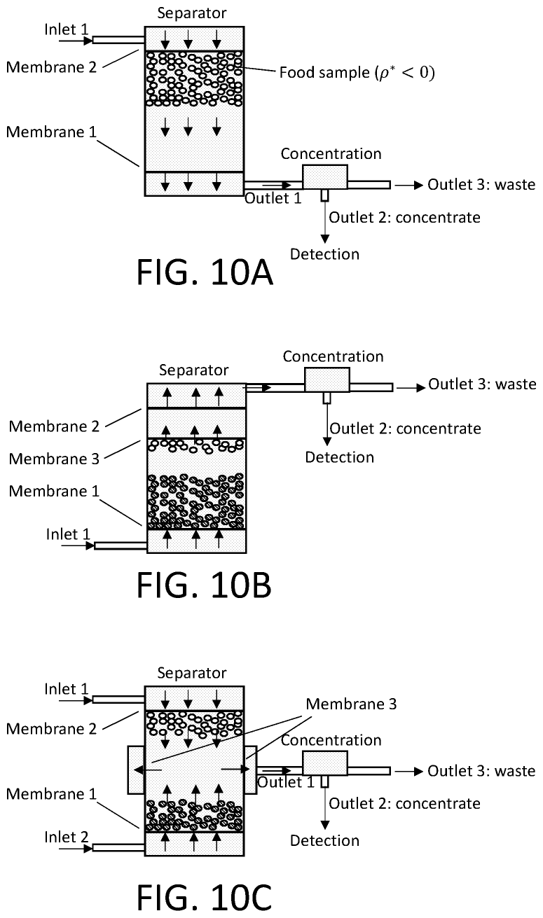

As used herein, the term “cavity” refers to an empty space. In some embodiments, the cavity is located within a solid object, for example, the MACE separator. In some embodiments, a cavity is defined by the walls of the MACE separator, a microfiltration membrane, and a screening member, for example, as illustrated as 408 or 409 in FIG. 4A. In other embodiments, a cavity is defined by the walls of the MACE separator and two microfiltration membranes, as illustrated by the space between membrane 1 and membrane 3 in FIG. 10B. In some embodiments, the cavity has fixed size. In some embodiments, the cavity may change sizes.

A “membrane” as used herein refers to a selective barrier which allows some components of a mixture to pass through but while preventing other components, based on size, shape, electrical charge, polarity or other physical characteristic. Such components that selectively pass through include but are not limited to molecules, ions, small or large particles, proteins, nucleic acids, pathogens, etc. A membrane can be of animal or biological origin, or synthetic. The degree of selectivity of a membrane depends on the characteristics of the membrane and the component mixture that is passing through the membrane. For example, if components of the mixture are being separated based on size, the selectivity of the membrane will depend on the membrane pore size. Membranes can also be of various thickness, with homogeneous or heterogeneous structure. Membranes can be neutral or charged, and component passage through the membrane can be active or passive. Based on the physical characteristics of the membrane, one or more physical processes will affect or facilitate filtration. For example, pressure, electrical charge, concentration and the like can facilitate filtration according to the methods of the present invention.

As used herein, the term “microfiltration” refers to a type of physical filtration process where a contaminated fluid is passed through a special pore-sized membrane to separate microorganisms and suspended particles from a test sample. In some embodiments, the microfiltration membranes have a pore size within the range of about 0.1 microns (micrometer, or μM) to about 40 microns. In some embodiments, the microfiltration membranes have a pore size within the range of about 0.45 microns to about 40 microns. In some embodiments, the microfiltration membranes have a pore size within the range of about 1 micron to about 30 microns. In some embodiments, the microfiltration membranes have a pore size within the range of about 2 micron to about 20 microns. In some embodiments, the microfiltration membranes have a pore size within the range of about 10 microns. In one embodiment, the microfiltration membrane has a pore size of about 5 microns. In some embodiments, the microfiltration membranes have a pore size within the range of about 3 microns.

In one embodiment, the MACE separator comprises one microfiltration membrane configured to contain a test sample, a screening member, a cavity between the microfiltration membrane and the screening member, a cavity above the microfiltration membrane, and a cavity below the screening member. An exemplary embodiment is depicted in FIG. 4A. In other embodiments, the MACE separator comprises more than one microfiltration membranes and a screening member. In this case, the MACE separator comprises a cavity below the screening member, a cavity between a microfiltration membrane and the screening member, one or more cavities between the more than one microfiltration membranes, and a cavity above the more than one microfiltration membranes. An exemplary embodiment is depicted in FIG. 10B. In certain embodiments, the test sample is contained in the cavity between a microfiltration membrane and the screening member. However, the test sample may be contained in other cavities as deemed necessary by a person skilled in the art.

As used herein, the term “screening member” refers to a filtration membrane or a sieving screen. A filtration membrane as used herein includes any type of membrane that can be used in a separation process for both mechanical and chemical sieving of particles and molecules, such as food particles and pathogens. A sieving screen generally comprises a wire mesh of openings, holes, or gaps, with specified or varied sizes, to separate a test sample containing particles or molecules into different groups based on their sizes. In some embodiments, a filtration membrane or a sieving screen can be used in connection with vibration applied. A skilled person in the art would know how to choose the type of filtration membrane or sieving screen according to the specific application of the devices or methods disclosed herein.

In certain embodiments of the MACE separator, the screening member supports the flow through of the test sample. In one embodiment, the screening member holds sediment particles of the test sample. In another embodiment, the cavity below the screening member holds sediment particles of the test sample.

In one embodiment, the MACE separator comprises one inlet and one outlet. In another embodiment, the MACE separator comprises more than one inlet and one outlet. In yet another embodiment, the MACE separator comprises one inlet and more than one outlet. In one embodiment, the MACE separator comprises more than one inlet and more than one outlet. The inlets and outlets as used herein refer to small openings where fluid can flow in and out as needed. The inlets and outlets can be positioned on any side of the separator as needed. In certain embodiments, one or more of the inlets, outlets, or both are connected to a valve. In certain embodiments, the valve is connected to a vacuum.

In another embodiment, the MACE separator further comprises a flow liquid. Examples of the flow liquid include but are not limited to water, culture medium, a buffered solution and/or mixtures thereof.

A culture medium can be any type of medium used in laboratories or in vitro to grow different kinds of microorganisms or cells. A growth or a culture medium is composed of different nutrients that are essential for the growth of the microorganisms or the cells. A growth medium or culture medium can be solid, liquid, or semi-solid. In some embodiments, the culture medium is designed for cell culture. In other embodiments, the culture medium is designed for microbiological culture, which are used for growing microorganisms, such as bacteria or fungi. In some embodiments, the culture media for microorganisms are nutrient broths. In other embodiments, the culture media for microorganisms are agar plates.

A buffered solution is generally an aqueous-based solution consisting of a mixture of a weak acid and its conjugate base, or vice versa. As one of skill in the art will know, buffered solutions can be used to maintain pH at a stable value. Common buffer compounds include, but are not limited to, TAPS ([Tris(hydroxymethyl)methylamino]propanesulfonic acid), Bicine (2-(Bis(2-hydroxyethyl)amino)acetic acid), Tris (Tris(hydroxymethyl)aminomethane) or (2-Amino-2-(hydroxymethyl)propane-1,3-diol), Tricine (3-[N-Tris(hydroxymethyl)methylamino]-2-hydroxypropanesulfonic acid), TAPSO (3-[N-Tris(hydroxymethyl)methylamino]-2-hydroxypropanesulfonic acid), HEPES (4-(2-hydroxyethyl)-1-piperazineethanesulfonic acid), TES (2-[[1,3-dihydroxy-2-(hydroxymethyl)propan-2-yl]amino]ethanesulfonic acid), MOPS (3-(N-morpholino)propanesulfonic acid), PIPES (Piperazine-N,N′-bis(2-ethanesulfonic acid)), Cacodylate (Dimethylarsenic acid), and MES (2-(N-morpholino)ethanesulfonic acid).

In one embodiment, the flow liquid flows through one or more of the following components: the one or more inlets, the one or more microfiltration membranes, the screening member, the test sample, and the one or more outlets. In some embodiments, the flow liquid flows at average velocity within the range of about 1 mm/min to about 40 mm/min. In other embodiments, the flow liquid flows at average velocity within the range of about 5 mm/min to about 30 mm/min. In one embodiment, the flow liquid flows at average velocity of about 10 mm/min. In another embodiment, the flow liquid flows at average velocity of about 4 mm/min. In certain embodiments, the flow liquid flows at flow rates within the range of about 5 ml/hour to about 4 L/hour. In certain embodiments, the flow liquid flows at flow rates within the range of about 50 ml/hour to about 4 L/hour. In certain embodiments, the flow liquid flows at flow rates of about or below 75 ml/hour. In certain embodiments, the flow liquid flows at flow rates within the range of about 100 ml/hour to about 4 L/hour. In certain embodiments, the flow liquid flows at flow rates within the range of about or greater than 4 L/hour.

In additional embodiments, the present disclosure provides methods for rapid detection of pathogens in food samples. Testing may be applied to any food including meats, spices, beverages, produce, pet food, snacks, ready to eat food etc. The methods may be used to detect the presence of any cellular contaminant or pathogen where the maintenance of cellular viability is important in the sample preparation process. Pathogens may include any bacteria or fungus. In preferred embodiments, ground beef or ground turkey may be tested for the presence of pathogens such as E. coli O157H7, E. coli STEC, Listeria, Campylobacter and Salmonella.

In one embodiment, the present disclosure provides methods for separating pathogen from a test sample. In certain embodiments, the methods generally comprise extracting the pathogen from the test sample by processing the sample in the MACE separator provided herein.

As used herein, the terms “pathogen,” “target pathogen,” and “pathogen analyte(s)” are used interchangeably and refer to any microorganisms, cells, or other infectious agents that may cause diseases or untoward or deleterious symptoms in an animal, such as human. As used herein, pathogen comprises bacteria, virus, fungi, and protozoa. The term “bacteria” is used herein to mean one or more viable bacteria existing or co-existing collectively in a test sample. The term may refer to a single bacterium (e.g., Aeromonas hydrophilia, Aeromonas caviae, Aeromonas sobria, Streptococcus uberis, Enterococcus faecium, Enterococcus faecalis, Bacillus sphaericus, Pseudomonas fluorescens, Pseudomonas putida, Serratia liquefaciens, Lactococcus lactis, Xanthomonas maltophilia, Staphylococcus simulans, Staphylococcus hominis, Streptococcus constellatus, Streptococcus anginosus, Escherichia coli, Staphylococcus aureus, Mycobacterium fortuitum, and Klebsiella pneumonia), a genus of bacteria (e.g., streptococci, pseudomonas and enterococci), a number of related species of bacteria (e.g., coliforms), an even larger group of bacteria having a common characteristic (e.g., all gram-negative bacteria), a group of bacteria commonly found in a food product, an animal or human subject, or an environmental source, or a combination of two or more bacteria listed above. Exemplary of common foodborne pathogens include Salmonella, E. coli O157H7, E. coli STEC, Listeria, Campylobacter, Clostridium botulinum, Staphylococcus aureus, Shigella, Toxoplasma gondii, Vibrio vulnificus, and Norovirus. As used herein, the term “colony forming unit” (CFU) means live pathogens capable of forming a colony in a plate.

In one embodiment, the extraction can be completed in less than about 10 minutes. In another embodiment, the extraction can be completed in less than about 30 minutes. In another embodiment, the extraction can be completed in less than about one hour. In another embodiment, the extraction can be completed in less than about four hours. In yet another embodiment, the extraction can be completed in less than about eight hours.

In one embodiment, the extraction can be enhanced by mixing the sample inside the device as liquid flows past the sample. In an exemplary embodiment, the mixing is performed with a shaker. In another embodiment, the extraction can be enhanced by controlling the temperature of the liquid past the sample to reach the optimal temperature for the growth of the specific pathogen or pathogens. In some embodiments, the temperature may be increased. In other embodiments, the temperature may be decreased.

In one embodiment, the extraction is independent of the ability of the bacteria to swim. In another embodiment, the extraction can be enhanced by adding a surfactant to the liquid that flows passed the sample. Exemplary surfactants include, but are not limited to, TWEEN or polyethylene glycol (PEG). In one embodiment, the surfactant is 1% TWEEN. The optimal concentration of the surfactants can be determined by one skilled in the art. In certain embodiment, the surfactant is to aid in removing bacteria from the sample surface. In certain embodiments, the extraction can be enhanced by preventing bacteria from attaching to new surfaces, such as the filter-membrane surface.

In certain embodiments, the extraction is accomplished by flow liquid past the sample at flow rates lower than about 75 ml/h. In certain embodiments, the extraction is accomplished by flow liquid past the sample at typical flow rates range of about 75 ml/h to about 4 L/h. In certain embodiments, the extraction is accomplished by flow liquid past the sample at flow rates greater than about 4 L/h. In certain embodiments, the food sample is about 25 grams (g) or less. In certain embodiments, the food sample is between 25 g to 375 g. In certain embodiments, the food sample is about 375 g or more. In certain embodiments, the extraction is accomplished by flow liquid past the sample at typical flow rates range of about 75 ml/h to about 500 ml/h for 25 g of food sample. In certain embodiments, the extraction is accomplished by flow liquid past the sample at typical flow rates range of about 1 L/h to about 4 L/h for up to 375 g food sample size. In certain embodiments, the extraction is accomplished by flow liquid past the sample at typical flow rates range of about 1 L/h to about 4 L/h for 25 g food sample size for food samples that are difficult to extract, such as chocolate, spices, and flour, etc.

In certain embodiments, the extracted sample may be investigated via molecular methods such as PCR or through plating on selective media to identify specific pathogens. In one exemplary embodiment, the resulting concentrated sample may be assayed for contamination by polymerase chain reaction (PCR)-based detection techniques. In another embodiment, the resulting concentrate may be assayed for contamination by plating on selective media for specific pathogens.

Following the methods for separating pathogen from a test sample provided herein, the extracted sample containing the pathogen can be further processed or preserved by techniques commonly used in the art, including but not limited to, dilution, concentration, freezing, freeze-drying or lyophilization, cryopreservation, hypothermic preservation, and vitrification.

Although the detection of foodborne pathogens is an important application of the present disclosure, the method may, of course, also be applied to samples of other origin, including but not limited to, samples for clinical or environmental assays, such as blood, urine, etc.

The term “about” or “approximately” as used herein means within 20% of a given value or range, i.e., plus and minus 20% of a value. In a more specific embodiment “about” means within 10% of a given value or range, i.e., plus and minus 10% of a value. In a more specific embodiment “about” means within 5% of a given value or range, i.e., plus and minus 5% of a value. In an even more specific embodiment “about” means within 2% of a given value or range, i.e., plus and minus 2% of a value.

Unless defined otherwise, all technical and scientific terms used herein have the same meaning as commonly understood by one of ordinary skill in the art (e.g., in microbiology, cell culture, molecular genetics, nucleic acid chemistry, and biochemistry). Standard techniques are used for molecular, genetic, and biochemical methods.

II. Exemplary Devices and Methods

In other embodiments of the present disclosure, a device and/or method for rapid and efficient pathogen separation from test samples are provided. In one embodiment, the device comprises three chambers separated with horizontal membranes to separate pathogen from test samples, such as food samples, introduced between the membranes. In one embodiment, the device is based on flow liquid from bottom to top slowly. In another embodiment, the device and/or method is leveraging the fact that the sample sinks while the fluid moves upward, dragging small particulates such as bacteria mainly due to their high surface to volume ratio, and in a lesser degree large food particles due to a higher surface to volume ratio or higher density.

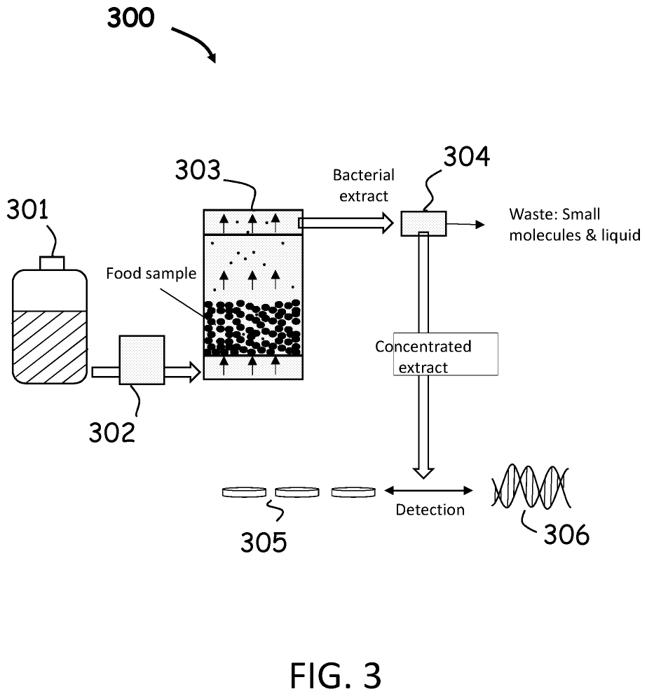

FIG. 3 shows a diagram with an example of the method of the disclosure. Particularly, it shows different steps of the process for the detection of bacteria in food samples. The steps include pumping 302 liquid from a reservoir 301, into a separation device (303) containing a food sample with bacteria. The separation device retains the food sample and separates the bacteria that are carried by the fluid flow. The new type of separation is called “Microfiltration Assisted by Counterflow Elutriation” (herein referred as MACE). An exemplary MACE separator is illustrated as member 303 in FIG. 3. Introducing the liquid containing the extracted bacteria from the MACE separator into an ultrafiltration concentrator (304), where the bacteria are concentrated and collected for downstream detection by bacterium culture (305) or PCR (306).

FIG. 4A shows a depiction of one exemplary embodiment of a fully assembled MACE separator. In the exemplary embodiment, the MACE separator (303) has three cavities (407, 408, and 409) separated by two filter membranes (402 and 405, FIG. 4B). The lowest cavity 409 has at least one inlet 411, and the top cavity 407 has one outlet 410. In the exemplary embodiment, the MACE separator is composed of two parts depicted in FIG. 4B. The top part 400 is composed of a plastic part 401 holding the filter membrane 402. The bottom part is composed of a plastic part 404 holding the filter membrane 405. A gasket 412 seals both parts when they are pressed against each other.

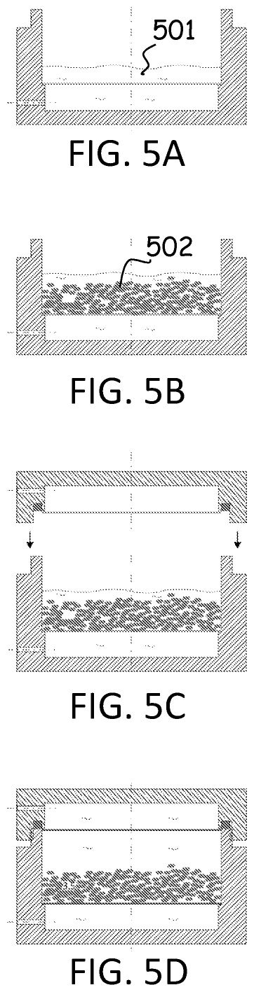

FIGS. 5A-5D illustrate an exemplary method for loading the MACE separator. Initially, only part 401 of the separator is used independent of part 402. After some loading steps detailed later, parts 401 and 402 are brought together and the MACE separator is operated as an assembly. First, as shown in FIG. 5A, liquid 501 is introduced through the inlet 411 filling completely cavity 409, and partially the volume on top of the membrane additional fluid is introduced past the membrane 405. At this point, only part 401 of the MACE separator is used. Second, as shown in FIG. 5B, a food sample 502 is introduced in the volume above membrane 405. The food sample may be mixed gently with the liquid above the membrane. Digestion enzymes may be used to mix with the liquid containing bacteria that comes out of the MACE separator. Any such food particles are smaller than the pore size of the MACE separator (e.g., ≤3 μm). Thus, digestion enzymes can digest any small food particulates that may accumulate in the pores of the membrane of the concentrator. Exemplary digestion enzymes include proteinases, proteases, cellulases, etc. Third, as shown in FIG. 5C, part 402 and part 401 are brought together making a tight fit and constituting the fully assembled MACE separator 303. Fourth, FIG. 5D, more liquid is introduced though inlet 411 until it overflows through outlet 410 after having filled the volume of all cavities 407, 408, and 409.

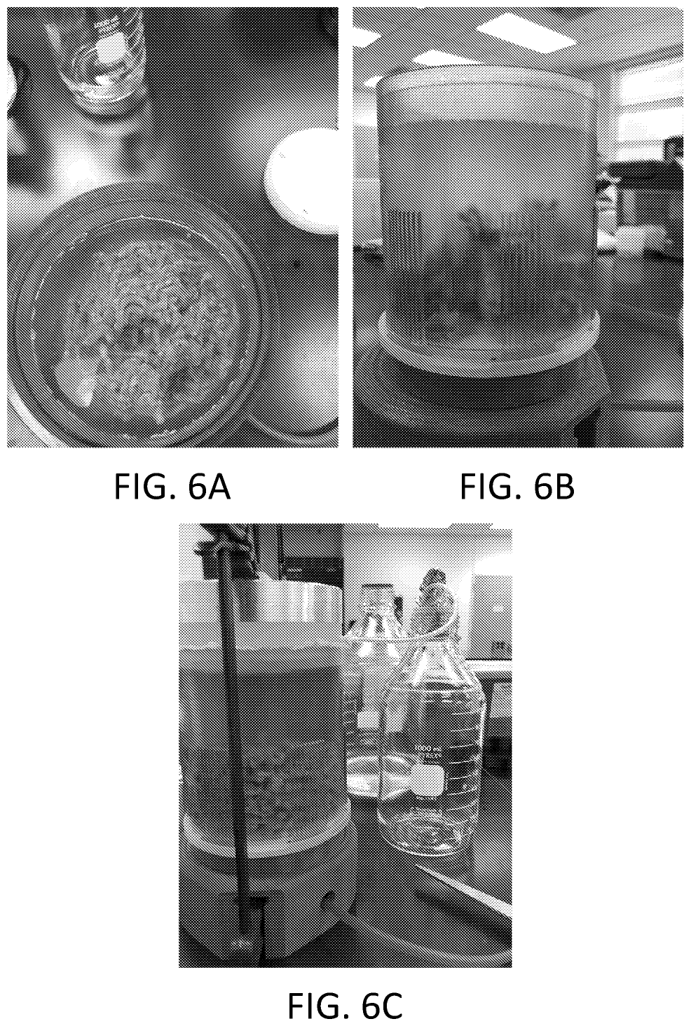

FIGS. 6A-6C show an exemplary reduction to practice of the embodiment detailed above. FIG. 6A and FIG. 6B show different views of part 401 of a MACE separator loaded with 187 g of 20% lean ground beef, at the loading step corresponding to FIG. 5B. FIG. 6C shows the MACE separator fully assembled and loaded, at a stage corresponding to FIG. 5D.

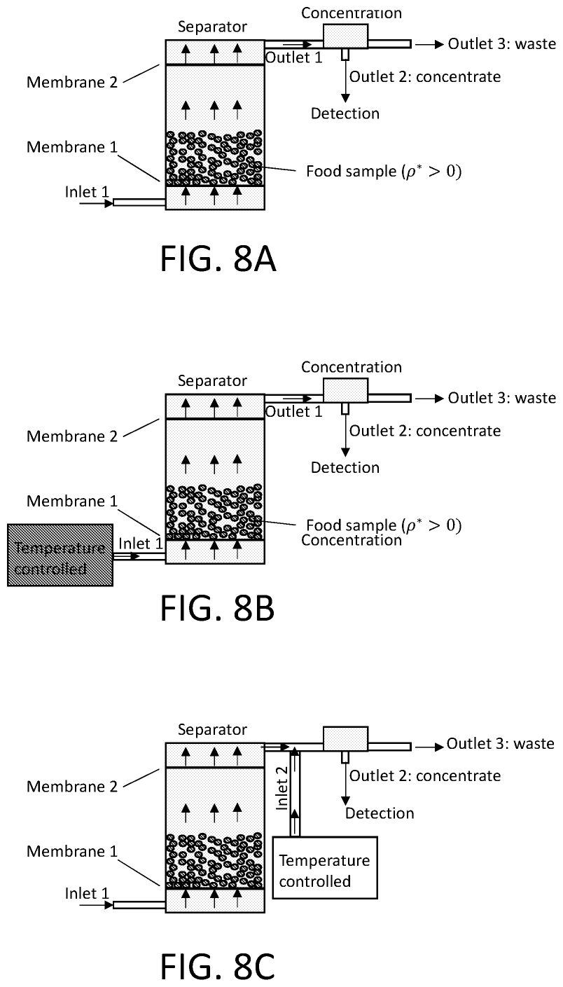

FIGS. 8A-8C illustrate different methods or configurations of operation. In particular, FIG. 8A shows a diagram with the method and embodiment described in FIG. 3. FIG. 8B shows a variation of the embodiment shown in FIG. 8A where the liquid introduced into the device is temperature controlled—heated or cooled. The liquid can be water, or bacterial enrichment broth that is universal or specific to a given pathogen. FIG. 8C shows a variation of the embodiment shown in FIG. 8A where temperature-controlled liquid is merged to the liquid extracted from the MACE separator and the mixture is introduced into the concentrator.

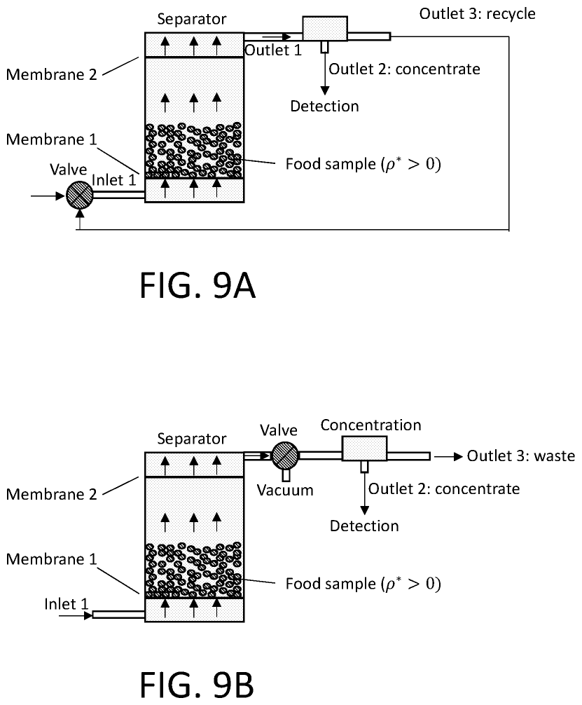

FIGS. 9A and 9B illustrate additional methods or configurations of operation. Specifically, FIG. 9A shows a variation of the embodiment depicted in FIG. 8A, where the liquid filtrate past the concentrator is reintroduced at the inlet of the device, thereby minimizing the amount of liquid in the reservoir. FIG. 9B shows a variation of the first embodiment where vacuum is applied on the food sample at the sample loading step shown in FIG. 5B to remove any air bubbles that may get trapped between food particles, and to remove air bubbles attached to small crevices or hydrophobic surfaces present in some food samples.

FIGS. 10A-10C illustrate additional methods or configurations of operation. In particular, FIG. 10A shows a variation of the embodiment depicted in FIG. 8A, where the food sample's relative density is negative, which means that the food sample floats. The principle works the same but in reverse. In this case, liquid is pumped into the device downwards, in the opposite direction to the floating velocity of the particles. FIG. 10B shows a variation of the first embodiment where some particles in the food sample have a relative density negative and other positive—meaning that some particles float and others sink. In this case, liquid is pumped through to inlets, one downwards and the other upwards, and the liquid is collected in the center passed a filter membrane. FIG. 10C shows a variation of the first embodiment where some particles in the food sample have a relative density negative and other positive—meaning that some particles float and others sink. In this case, liquid is pumped through the inlet at the bottom, and a third filter-screen (Membrane 3) with larger openings than membrane 2 is placed prior to membrane 2. The combination of two filter membranes with 15% open area made of pores randomly located ensures that the pores of both membranes are not aligned, and ensure trapping of most floating particles.

The present disclosure also encompasses compositions, devices, and/or kits thereof. Those skilled in the art will recognize that numerous modifications and changes may be made to the preferred embodiment without departing from the scope of this application.

### EXAMPLES

It is understood that the examples and embodiments described herein are for illustrative purposes only and that various modifications or changes in light thereof will be suggested to persons skilled in the art and are to be included within the spirit and purview of this application.

### Example 1: Separation of Pathogen from Ground Meat

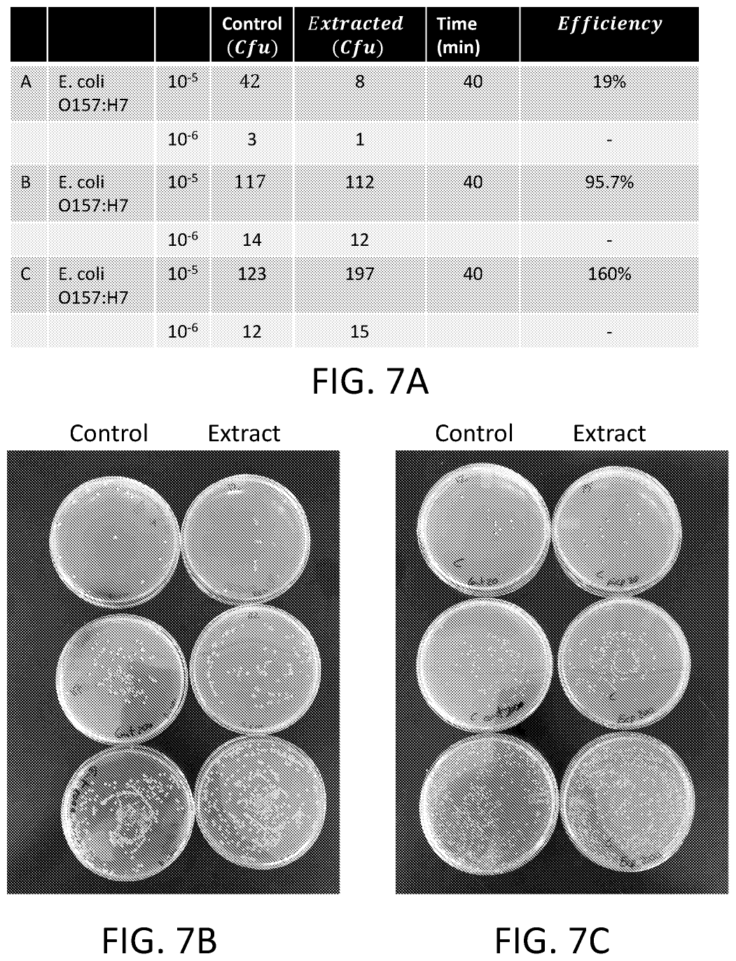

Example 1 demonstrates the application and results of operating a MACE separator for separating E. coli O157H7 from 187 g of ground Beef. The results are shown in FIGS. 7A-7C.

I. Methods

Tap water is used as the liquid introduced into the MACE separator. The volume of the chamber where the food sample is introduced was 850 ml. A 0.45 pore size polyethersulfone (PES) membrane was used as the bottom membrane. A polycarbonate (PCTE) membrane (PCT3014220 Sterlitech, WA, USA) with 3-micron (μm) pore size is used as top membrane. The PES and PCT membranes are commercially available from, for example, MilliporeSigma (Germany) or Thermo Fisher Scientific (Grand Island, N.Y.). A peristaltic pump is used to introduce typically 1 L or 2 L of water through the inlet of the MACE separator typically within 40 minutes depending on the experiment. The diameter of the filter membranes is 100 mm, which results in average flow velocity of around 4 mm/min. The liquid with extracted bacteria is collected from the outlet of the separator and reserved in a 2 L capacity sterilized glass bottle. 20 μL of an overnight culture of bacteria E. coli O157:H7 resistant to the antibiotic Kanamycin is pipetted into the 185 g of ground beef and let to rest until it is fully absorbed prior to introducing the artificially contaminated food sample into the MACE separator. As control, another 20 μL of the same overnight culture is pipetted into a second sterilized glass bottle containing the same volume of tap water introduced into the MACE separator. At the end of the experiment (30 to 45 minutes depending on the experiment), an aliquot of both the liquid extract from the MACE separator is diluted and plated on LB agar plates containing the antibiotic Kanamycin. After 12 hours of incubation, colonies are counted. The same procedure is simultaneously performed with an aliquot of the liquid in control experiment. The efficiency of the separation is calculated as the number of CFU/ml (colony forming units/ml) of E. coli O157:H7 extracted from the sample using the MACE separator divided by the number of CFU/ml of E. coli O157:H7 used to contaminate the food sample.

II. Results

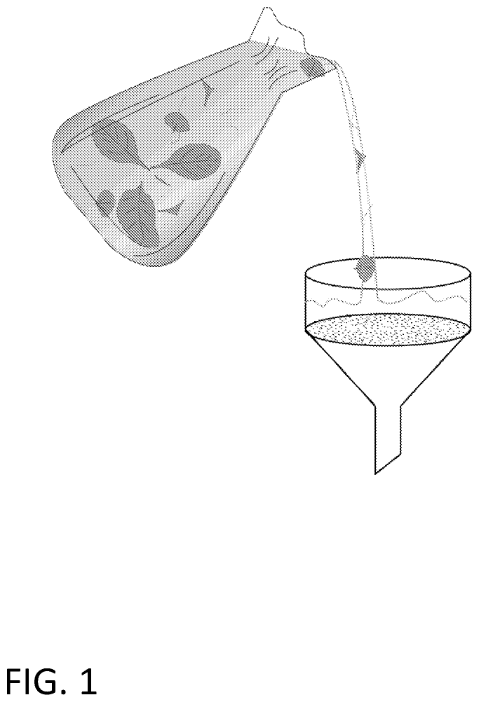

The results of three tests with different experimental conditions are provided in FIG. 7A. The volume pumped in experiments A, B, and C is 1 L, 2 L, and 1 L respectively. Experiment C differed from experiment A only in that the MACE separator is rocked manually (short sudden horizontal movements) during the 40 minutes' separation. FIG. 7B shows bacterial colonies grown in plates corresponding to experiment B. FIG. 7C shows bacterial colonies grown in plates corresponding to experiment C. Additional control experiments are performed to evaluate the performance of the separation without top membrane (Elutriation). In all cases, great quantities of food sample particles are obtained through the outlet and failed to result on the isolation of bacteria. Further, experiments are performed by pouring artificially contaminated food samples, diluted 1:9 in Buffered Peptone Water (BPW) into standard filters as depicted in FIG. 1 (Microfiltration). In all cases, the filters became clogged after extraction of less than 10 ml, even if the diluted food sample is prefiltered with a standard filter bag.

III. Discussion

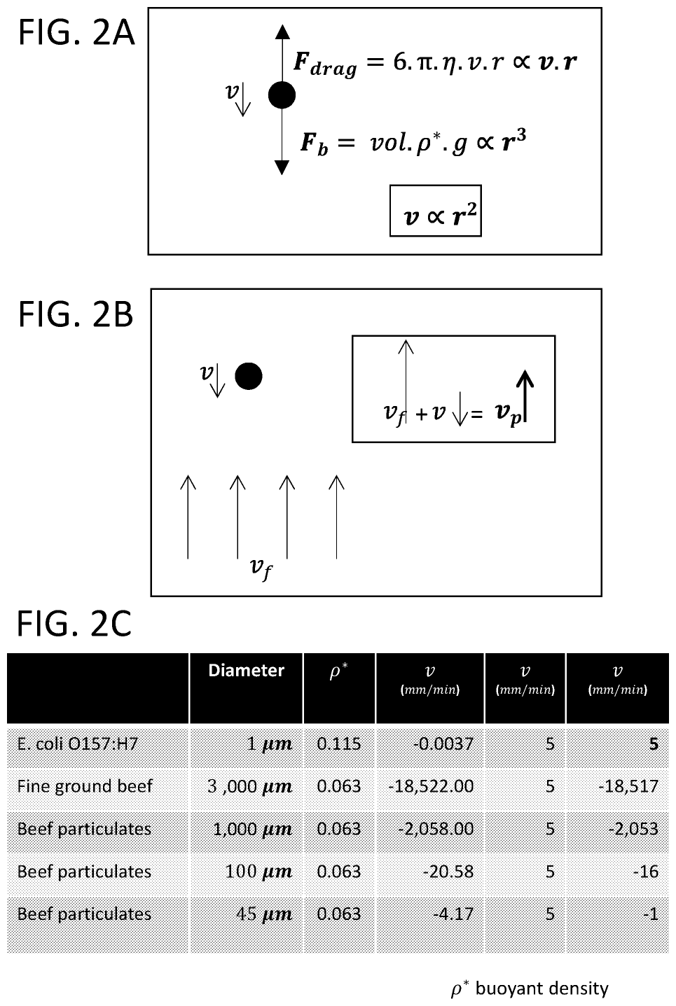

The results of the experiments A, B, and C and the results of the control experiments for microfiltration alone, or elutriation alone, show that, surprisingly, both microfiltration and elutriation only work well when used in combination. In other words, there is a synergetic effect between both approaches when combined that results in the rapid and efficient separation of bacteria from 187 g of food sample in only 40 minutes. This example demonstrates that the rapid and efficient separation of food-borne pathogen achieved by the present disclosure cannot be extrapolated from results of using each microfiltration or elutriation technique alone. As shown by the present example, the method using microfiltration or elutriation alone failed miserably. The geometry of the MACE separator and the flow rate are designed to produce an average flow velocity of approximately 4 mm/min inside the middle chamber of the device based on calculations of sedimentation rates of ideal spherical particles of muscle tissue, as shown in FIGS. 2A-2C. Specifically, in a 4 mm/min velocity field, bacteria should move with the flow, and ideally, muscle particles with a diameter greater than 30 microns should remain in place or sediment. This exemplary model does not account for fat particles that float and thus should have a velocity towards the top membrane greater than the flow velocity, or large muscle particles with non-spherical shapes that may be dragged by the flow. After the experiments, the MACE separator is carefully disassembled and examined. It is observed that a layer of mostly fat particles adhered to the membrane. Nonetheless, in all experiments, the top membrane did not clog and only particles with diameters smaller than 3 microns (mostly bacteria) are recovered through the outlet. There are two potential explanations: (1) floating particles accumulate on the membrane, but at low flow rates these particles do not experience enough pressure drop that would deform their shape clogging the filter pores, and (2) floating particles move quickly vertically compared to the velocity of the flow towards the pores without altering their direction significantly and adhere to random regions of the membrane. Since the membranes have an open area of around 16%, most floating particles would end in regions without pores. Most probably, the actual explanation for the results is a combination of both. Last, experiment C shows an extraction efficiency greater than 100%, as compared to control, probably due to the continued growth of bacteria immersed in “meat juice” during the extraction. Thus, it is hypothesized that the flow through sedimented food particles would preferentially follow specific low-resistance routes through the interstices of the sedimented particles and avoid routes with higher resistance to flow, such as smaller gaps between particles. The goal of shaking the device in experiment C is to move the sedimented particles based on their inertial properties, creating new flow paths covering regions that otherwise would not experience significant fluid flow.

The combination of microfiltration and counter flow elutriation at low flow rates results in rapid and extraordinarily efficient separation of bacteria from food samples.

What is claimed is:

1. A Microfiltration Assisted Counterflow Elutriation (MACE) separator, comprising:
a) at least one microfiltration membrane configured to contain a test sample,
b) a screening member,
c) a cavity between the at least one microfiltration membrane and the screening member containing the test sample, a cavity above the at least one microfiltration membrane, and a cavity below the screening member,
d) one or more inlets, and
e) one or more outlets.

2. The MACE separator of claim 1 or 2, wherein the MACE separator has more than one microfiltration membranes.

3. The MACE separator of claim 3, further comprising one or more cavities between the more than one microfiltration membranes and a cavity above the more than one microfiltration membranes.

4. The MACE separator of any one of the preceding claims, wherein the microfiltration membranes have a pore size within the range of about 0.45 microns to about 40 microns.

5. The MACE separator of any one of the preceding claims, wherein the microfiltration membrane has a pore size of about 3 microns.

6. The MACE separator of claim 1, wherein the screening member is a filtration membrane or a sieving screen.

7. The MACE separator of any one of the preceding claims, wherein the screening member supports the test sample.

8. The MACE separator of any one of the preceding claims, wherein the screening member holds sediment particles of the test sample.

9. The MACE separator of any one of the preceding claims, wherein the cavity below the screening member holds sediment particles of the test sample.

10. The MACE separator of any one of the preceding claims, wherein the separator comprises one inlet and one outlet.

11. The MACE separator of any one of the preceding claims, wherein the separator comprises more than one inlet and one outlet.

12. The MACE separator of any one of the preceding claims, wherein the separator comprises one inlet and more than one outlet.

13. The MACE separator of any one of the preceding claims, wherein the separator comprises more than one inlet and more than one outlet.

14. The MACE separator of any one of the preceding claims, further comprising flow liquid.

15. The MACE separator of claim 14, wherein the flow liquid comprises one or more of water, a cultural medium, and a buffered solution.

16. The MACE separator of claim 14 or 15, wherein the flow liquid flows through one or more of following: the one or more inlets, the one or more microfiltration membranes, the screening member, the test sample, and the one or more outlets.

17. The MACE separator of any one of claims 14-16, wherein the flow liquid flows at average velocity within the range of about 1 mm/min to about 40 mm/min.

18. The MACE separator of any one of claims 14-16, wherein the flow liquid flows at average velocity of about 4 mm/min.

19. The MACE separator of any one of claims 14-16, wherein the flow liquid flows at flow rates within the range of about 100 ml/hour to about 4 L/hour.

20. The MACE separator of any one of the preceding claims, wherein the test sample is selected from the group comprising food sample, human tissue, human fluids, animal tissue, animal fluids, plant tissue, clinical sample, and environmental sample.

21. A method for separating pathogen from a test sample, comprising extracting the pathogen from the test sample by processing the sample in the MACE separator of any one of claims 1-20.

22. The method of claim 21, wherein the pathogen comprises one or more of Salmonella, E. coli O157H7, E. coli STEC, Listeria, Campylobacter, Clostridium botulinum, Staphylococcus aureus, Shigella, Toxoplasma gondii, Vibrio vulnificus, and Norovirus.

23. The method of claim 21, wherein the MACE separator comprises one or more inlets and one or more outlets.

24. The method of any one of claims 21-23, wherein the one or more inlets and one or more outlets are connected to a valve.

25. The method of claim 24, wherein the valve is connected to a vacuum.

26. The method of any one of claims 21-25, further comprising recovering the extracted pathogen from the MACE separator.
